(19) United States
(12) Patent Application Publication
(10) Pub. No.: US 2025/0198948 A1
(43) Pub. Date: Jun. 19, 2025

(54) PROCESSING SYSTEM AND PROCESSING METHOD CAPABLE OF AUTOMATICALLY MONITORING SURFACE FEATURES OF OBJECT

(71) Applicant: GLORY STEEL ENTERPRISE CO., LTD., Taichung City (TW)

(72) Inventors: YI-LIANG CHEN, Taichung City (TW); PAO-HSIN WANG, Taichung City (TW)

(73) Assignee: GLORY STEEL ENTERPRISE CO., LTD., Taichung City (TW)

(21) Appl. No.: 18/846,664

(22) PCT Filed: Feb. 16, 2023
(86) PCT No.: PCT/CN2023/076409

§ 371 Date: Sep. 13, 2024

(51) Int. Cl. G01N 21/956; B23K 26/70; G01N 21/88; G06T 15/00

(52) U.S. Cl. CPC G01N 21/956; B23K 26/70; G01N 21/8851; G06T 15/00

(57) ABSTRACT

A processing system capable of automatically monitoring surface features on an object, which is adapted to process a processing surface of the object, and the processing surface has at least one 3D feature marker. The processing system includes an image capturing device, a computing device, and a surface processing apparatus. The image capturing device is adapted to capture images of the processing surface. The computing device generates a 3D image data corresponding to the processing surface based on the images, and the 3D image data includes at least one marker label corresponding to the at least one 3D feature marker. The surface processing apparatus performs surface processing to the processing surface according to the 3D image data. The processing method conducted by using the processing system is provided herewith.

### BACKGROUND OF THE INVENTION

### Technical Field

The present invention relates generally to a surface processing technology for objects, and more particularly to a processing system and a processing method thereof capable of automatically monitoring surface features on the objects.

### Description of Related Art

During the production process of workpieces, such as metal parts for vehicles, shoe components, or wooden products, it is often necessary to perform surface treatments such as carving, painting, laser cutting, cutting, and polishing on the surface of the workpiece. When a processing surface of the workpiece is flat, the surface treatment is relatively simple, because the surface treatment operation only requires setting a surface treatment device to move on the flat processing surface of the workpiece to treat the processing surface of the workpiece. A conventional methods involve manually processing the processing surface of each of the workpieces.

With the advancement of automated processing technology, the efficiency of surface treatment of the workpieces could be improved relative to the conventional manual processing method. Specifically, the surface treatment of the workpiece applied the current automatic processing technology, requires a manually-established three-dimensional drawing of the workpiece in advance. In the three-dimensional drawing file, the size parameters and the processing positions and areas corresponding to the workpiece should be set, so that the surface treatment device could perform the surface treatment to the workpiece based on the parameter data in the three-dimensional drawing file.

However, the above-mentioned automatic surface treatment is specific to each kind of workpiece. Namely, the surface treatment for one workpiece cannot be directly used for processing other workpieces, which are in different shapes and sizes. For example, the size and shape of each shoe body are different. The dimensional drawing of each kind of shoe body has to be manually established and the processing parameters corresponding to each kind of shoe body have to be individually set in advance. Only after that, the surface treatment device could perform the surface treatment on each kind of shoe body. Therefore, the conventional automatic surface treatment method causes a heavy burden on the design staff, which reduces the efficiency of the processing line as well.

### BRIEF SUMMARY OF THE INVENTION

In view of the above, the primary objective of the present invention is to provide a processing system and a processing method that are capable of automatically monitoring of surface features of objects, which could perform an image analysis to a processing surface of various objects, so that the processing apparatus could perform surface treatments, such as treatments of patterns, sizes, and shapes, to 3D feature marks on each of various objects, thereby promoting the efficient of surface treatments.

The present invention provides a processing system capable of automatically monitoring surface features on an object, which is adapted to process a processing surface of the object, and the processing surface has at least one 3D feature marker. The processing system includes an image capturing device, a computing device, and a surface processing apparatus. The image capturing device is adapted to capture images of the processing surface of the object. The computing device is connected to the image capturing device, wherein the computing device generates a 3D image data corresponding to the processing surface based on the images captured by the image capturing device, and the 3D image data includes at least one marker label corresponding to the at least one 3D feature marker. The computing device records a coordinate of 3D processing corresponding to a location of the at least one marker label and calculates a processing path. The surface processing apparatus is connected to the computing device and is adapted to receive the 3D image data from the computing device, wherein the surface processing apparatus performs surface processing to the processing surface of the object according to the coordinate of 3D processing and the processing path in the 3D image data.

The present invention provides a processing method capable of automatically monitoring surface features on an object, which is adapted to process a processing surface of an object, and the processing surface has at least one 3D feature marker. The processing method includes the following steps:

Step S1: Capture images of the processing surface of the object via an image capturing device.

Step S2: Generate a 3D image data corresponding to the processing surface by the computing device based on the images captured via the image capturing device; and

Step S3: Receive the 3D image data by the surface processing apparatus and process the processing surface of the object according to the 3D image data.

The processing system capable of automatic monitoring of object surface features and the processing method allow to capture the image of the processing surface of the objects via the image capturing device on the production line first, and then the computing device generates the 3D image data corresponding to the processing surface of the object according to the images captured by the image capturing device, and identifies the location of the 3D marker. Finally, the surface processing apparatus performs surface processing on the processing surface of the objects. With such design, since the method of automatic surface processing could perform image recognition on the processing surfaces of various kinds of objects, the cost and human effort of manual drawing could be reduced. After the image recognition, the location of the 3D marker could be identified, and the processing surface of the objects corresponding to the 3D marker could be processed surface treatments, such as the treatment of pattern, size, and shapes surface, thereby achieving high-efficiency surface processing.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the structure of the processing system of an embodiment according to the present invention;

FIG. 2 is a front view of the structure of the processing system of the embodiment according to the present invention;

FIG. 3 is a top view of the structure of the processing system of the embodiment according to the present invention, wherein the shell is omitted;

FIG. 4 is a perspective of the object of an embodiment of the present invention;

FIG. 5 is a side view of the object of the embodiment of the present invention;

FIG. 6 is a side view of the processing system of the embodiment according to the present invention, showing the object is located in the first operation area;

FIG. 7 is a schematic front view of FIG. 6;

FIG. 8 is a block view of the computing device in the processing system of the embodiment according to the present invention;

FIG. 9 is a schematic view of the 3D image data used by the processing system of the embodiment according to the present invention;

FIG. 10 is a schematic view of the 3D image data in FIG. 9 with the processing parameter;

FIG. 11 is a side view of the processing system of the embodiment according to the present invention, showing the object is located in the second operation area;

FIG. 12 is a schematic view of the surface processing apparatus in the processing system of the embodiment according to the present invention, which is adapted to process the processing surface of the object;

FIG. 13 is a schematic view of the finished product of the embodiment according to the present invention;

FIG. 14 is a side view of the finished product of the embodiment according to the present invention;

FIG. 15 is a flowchart of the processing method capable of automatically monitoring the surface of the object of an embodiment according to the present invention;

### DETAILED DESCRIPTION OF THE INVENTION

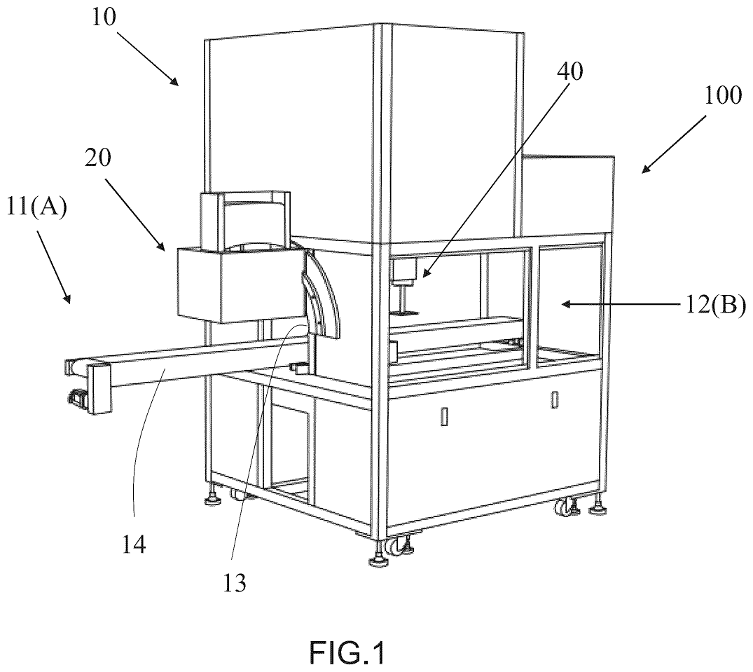

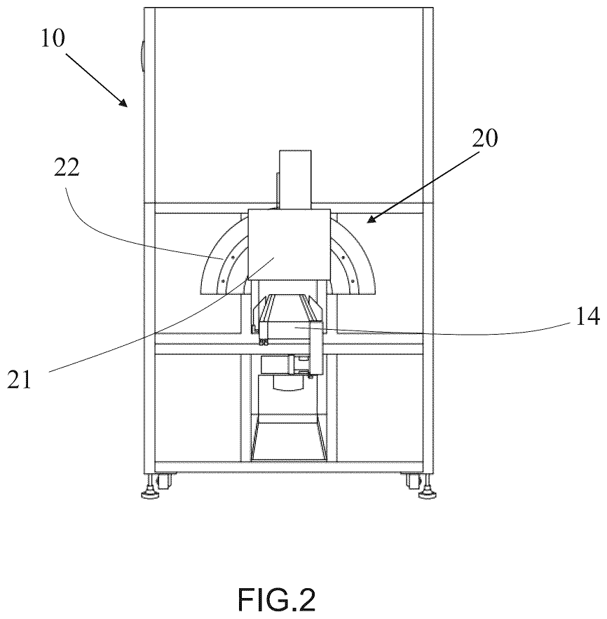

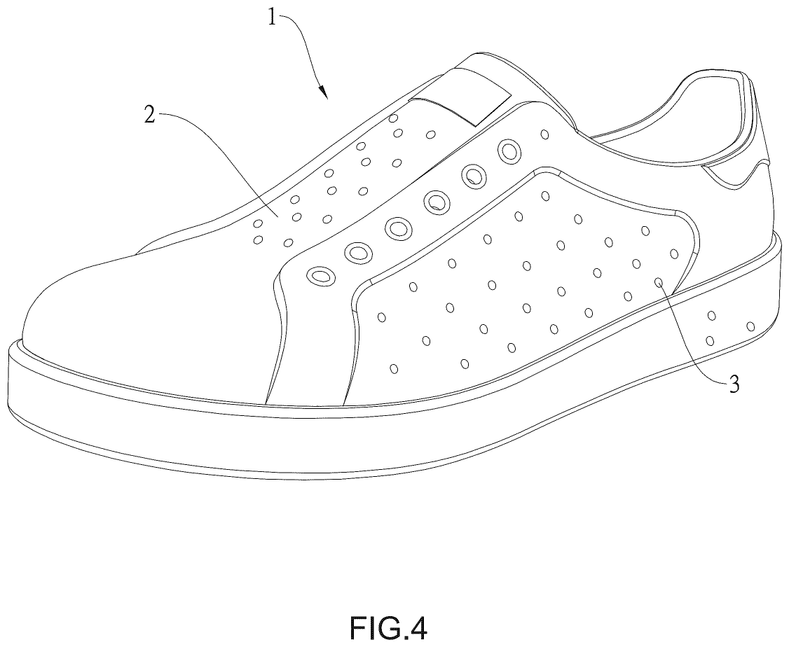

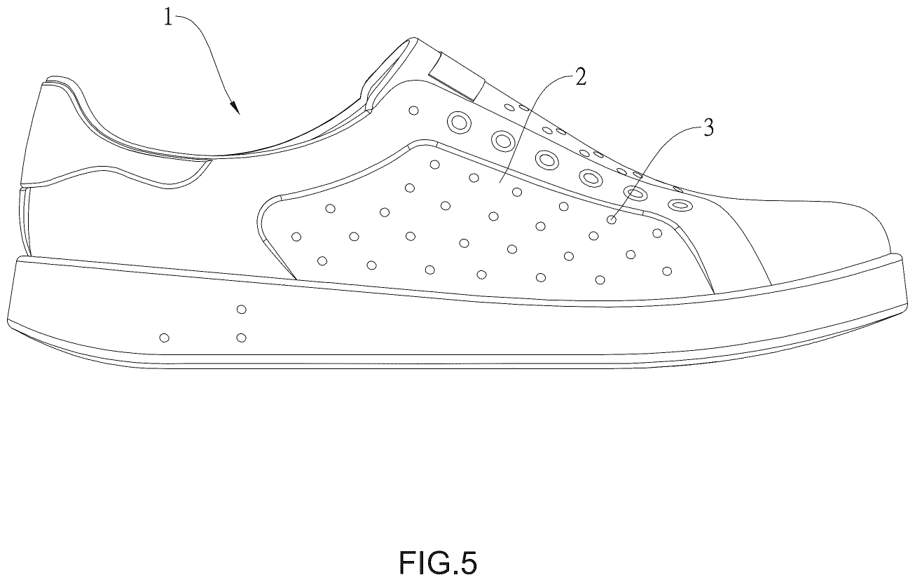

As illustrated in FIG. 1 to FIG. 3, a processing system 100 of an embodiment according to the present invention is capable of monitoring surface features of an object, which is adapted to process a processing surface 2 of an object 1, wherein at least one 3D feature marker 3 is disposed on the processing surface 2 in advance. As illustrated in FIG. 4 and FIG. 5, the object 1 of the current embodiment is a sport shoe as an example, wherein the processing surface 2 of the object 1 includes a shoe upper and a circumference of shoe sole, and there are a plurality of 3D feature markers 3 on the object 1. As illustrated in FIG. 4 and FIG. 5, the location of the 3D feature markers 3 is a relative location where the processing surface 2 of the object 1 is to be processed

In the current embodiment, the 3D feature markers 3 are circular holes as an example, but not limited to that. In other embodiments, the 3D feature markers 3 could be protruding spots, and the shape of the 3D feature markers 3 could be any geometric pattern, as long as the 3D feature markers 3 are three-dimensional. An amount and a location of the 3D feature markers 3 could be adjusted according to the processing requirement. For example, the amount of the 3D feature marker 3 could be one, and the 3D feature marker 3 is disposed on either the shoe upper or the circumference of shoe sole of the object 1.

Additionally, in other embodiments, the object 1 could be a workpiece in any shape or material, such as sheet metal, wood accessories, semi-conductor, and plastic product, as long as the workpiece that needs surface treatment could be the object 1. The distribution of the 3D feature markers 3 on the processing surface 2 of various objects should be arranged according to the processing requirements.

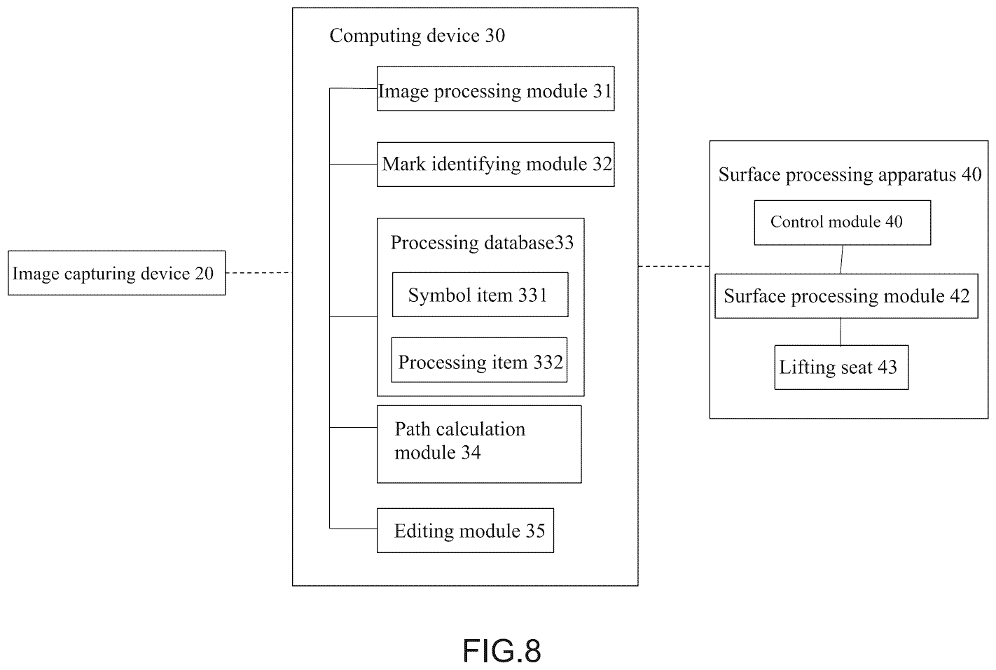

As illustrated in FIG. 1, a basic structure of the processing system 100 of the current embodiment includes a shell 10, an image capturing device 20, a computing device 30 (in FIG. 8), and a surface processing apparatus 40.

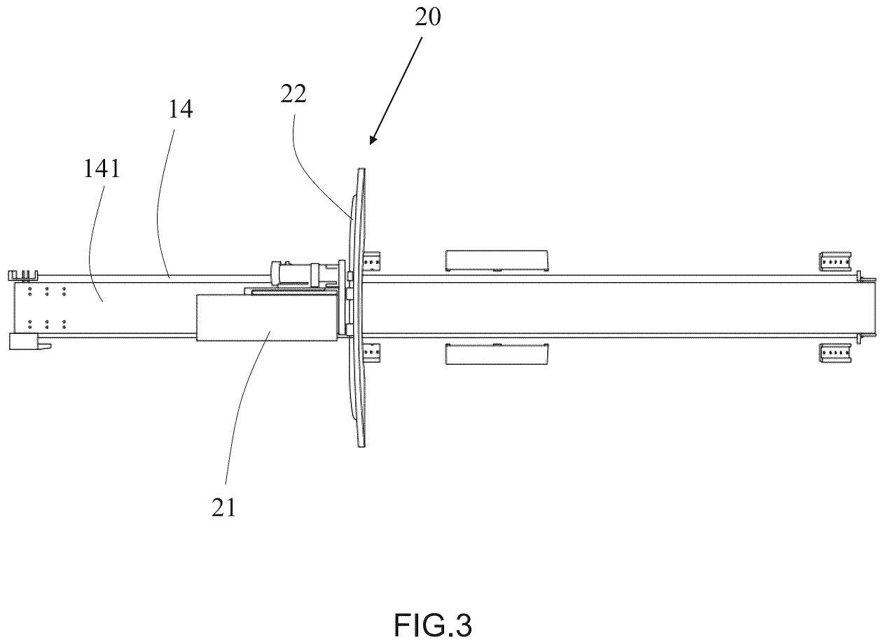

The shell 10 is mainly used for being mounted with the image capturing device 20 and the surface processing apparatus 40. As illustrated in FIG. 1 to FIG. 3, the processing system 100 is defined to have a first operating area A and a second operating area B, wherein the first operating area A is located at an outer space 11 of the shell 10, and the second operating area B is located at an inner space 12 of the shell 10. Besides, the shell 10 has an entrance 13 that allows the first operating area A to communicate with the second operating area B. Additionally, as illustrated in FIG. 1 and FIG. 3, a transmitting track 14 is disposed on the shell 10 and passes through the entrance 13, the first operating area A and the second operating area B. As illustrated in FIG. 3, the transmitting track 14 has a placement surface 141 for the object 1 to put. When the object 1 lies on the placement surface 141 of the transmitting track 14, the object 1 could be conveyed by the transmitting track 14 to move through the first operating area A, the entrance 13, and the second operating area B.

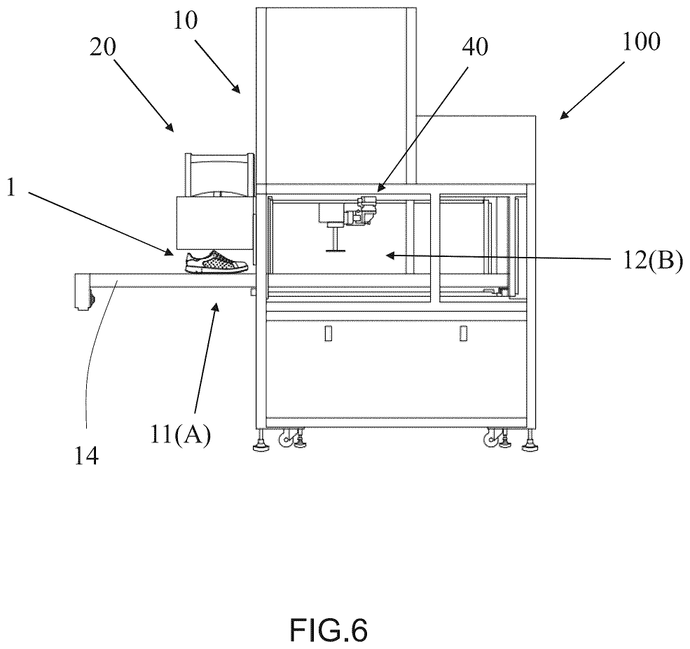

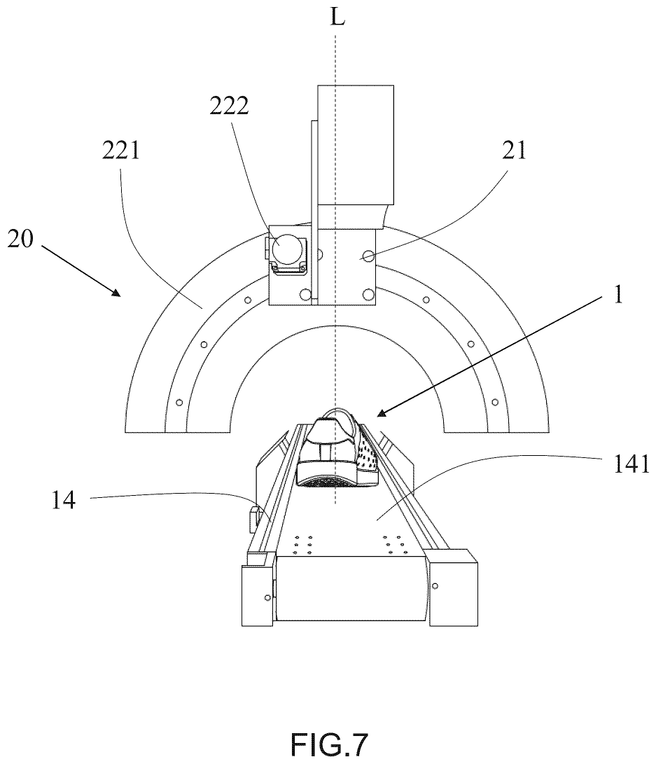

The image capturing device 20 is adapted to capture an image of the processing surface 2 of the object 1. As illustrated in FIG. 1 to FIG. 3, the image capturing device 20 is disposed in the first operating area A of the processing system 100. The image capturing device 20 includes a 3D camera module 21 and a drive module 22, wherein the 3D camera module 21 is suspended in the first operating area A, and the drive module 22 is connected to the 3D camera module 21 to drive the 3D camera module 21 to move within the first operating area A. In the current embodiment, the drive module 22 has an arc slide track 221 and a driver 222. As illustrated in FIG. 6 and FIG. 7, the arc slide track 221 is defined to have a center line L that passes through the placement surface 141 of the transmitting track 14. The arc slide track 221 is symmetrical by the center line L, and two ends of the arc slide track 221 bend to a side of the transmitting track 1. The driver 222 is disposed on the arc slide track 221 and is connected to the 3D camera module 21, so that the 3D camera module 21 could be driven to move along the arc slide track 221 by the driver 222. With such design, the 3D camera module 21 is driven by the driver 222 to capture images at various angles in the first operating area A.

In other embodiments, the image capturing device 20 could include a plurality of 3D camera modules (not shown). The 3D camera modules are fixed in the first operating area A and face the transmitting track 14. When the object 1 enters into the first operating area A, the 3D camera modules capture images of the processing surface 2 of the object 1 at various angles. Therefore, the image capturing device 20 is not limited to the 3D camera module 21 worked with the drive module 22, any structure that is able to properly and throughtly capture the images of the processing surface 2 of the object 1 could be used as the image capturing device 20.

The computing device 30 is connected to the image capturing device 20. In the embodiment, the computing device 30 is a data processor. The computing device 30 could generate a 3D image data P of the processing surface 2 of the object 1 based on the images captured by the image capturing device 20. The 3D image data P has a marker label t corresponding to each of the at least one 3D feature markers 3 on the object 1. The computing device 30 records a coordinate of 3D processing according to a position of the marker label t and calculates a processing path corresponding to said marker label t. In an embodiment, the processing path could be around the marker label t and does not pass through the marker label t, but is not limited to the abovementioned.

More specifically, as illustrated in FIG. 8 to FIG. 10, the computing device 30 of the current embodiment includes an image processing module 31, a mark identifying module 32, a processing database 33, a path calculation module 34 for calculating the processing path, and an editing module 35, which are connected to each other via signal.

The image processing module 31 is adapted to receive the images captured by the image capturing device 20 and perform an image processing to obtain the 3D image data P corresponding to a profile of the processing surface 2 of the object 1, wherein the 3D image data P includes the at least one marker label t. The mark identifying module 32 assesses or receives the 3D image data P from the image processing module 31 and is adapted to identify the marker label t in the 3D image data P and record the coordinate of 3D processing corresponding to the position of the marker label t in the 3D image data P.

The processing database 33 includes a symbol item 331 and a processing item 332. The symbol item 331 prestores a plurality of marker label data. In the current embodiment, the marker label data corresponds to a 3D symbol or 3D pattern of the 3D feature markers 3 on the object 1 (as shown in FIG. 4 and FIG. 5). The processing item 332 presets a plurality of processing parameters corresponding to each of the marker label data of the symbol item 331. In the current embodiment, the processing parameter includes processing size, processing angle, processing pattern, and processing depth, wherein the processing pattern could be different from the pattern of the 3D feature markers 3. For example, the 3D feature markers 3 in FIG. 4 is circular holes, and the symbol item 331 includes the marker label data corresponding to the 3D pattern of the 3D feature markers 3, and the processing item 332 could be processing parameters with the processing pattern of a circular hole, a star-shaped hole, or a heart-shaped symbol on the required demand.

The path calculation module 34 identifies the marker label t in the 3D image data and compares the marker label t with the symbol item 331 in the processing database 33. If one or more of the marker label t is identical to one of the marker label data of the symbol item 331, the path calculation module 34 could obtain the processing parameters of the processing item 332 corresponding to the one of the marker label data of the symbol item 331 and set the processing pattern of the processing parameter on the related marker label t in the 3D image data P. Then, the path calculation module 34 generates a processing initial coordinate corresponding to a processing initial point of the processing pattern on the related marker label t. In the current embodiment, the processing initial coordinate is an initial position of the surface processing, which could be different from the coordinate of 3D processing corresponding to the marker label t. The path calculation module 34 calculates the processing path of the processing pattern starting from the processing initial coordinate, and the coordinate of 3D processing of the marker label t is located on the processing path.

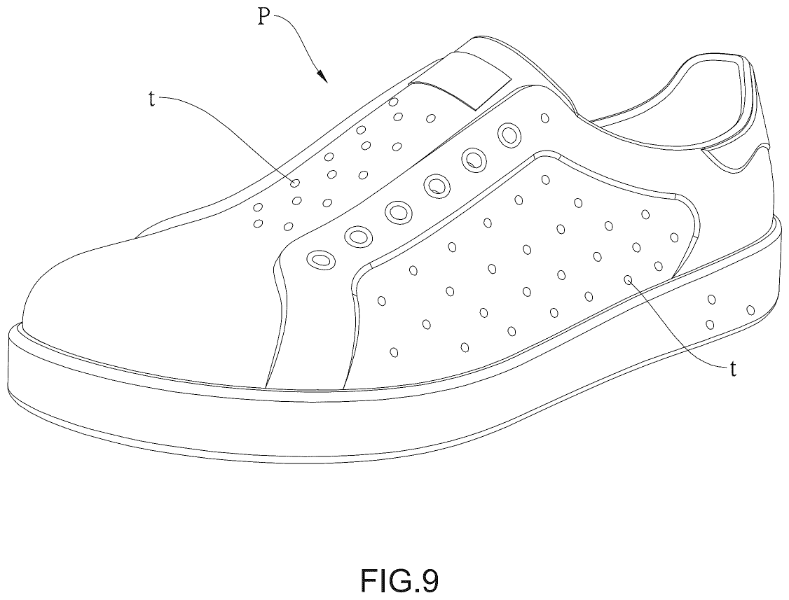

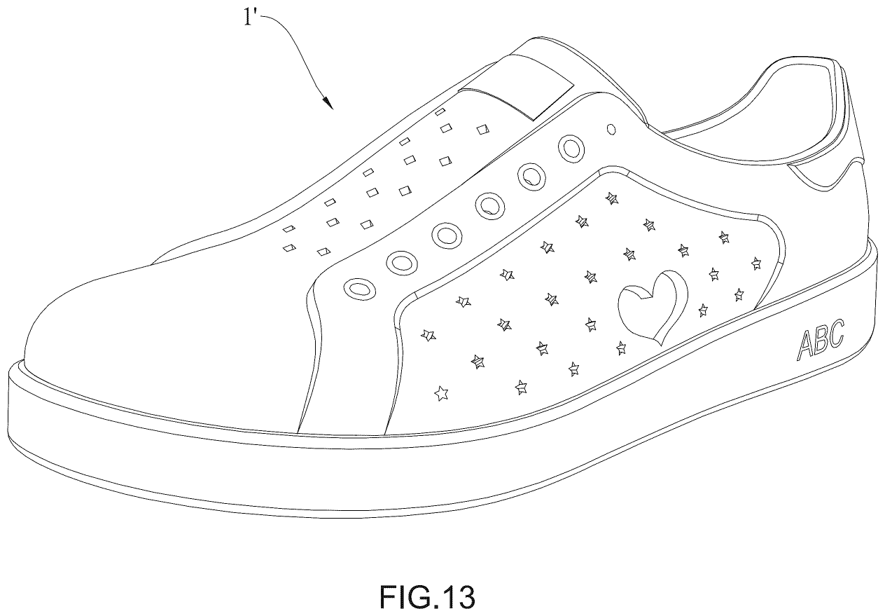

The editing module 35 could be used for preset the symbol item 331 and the processing item 332 in the symbol item 331, so that the surface processing could be customized. For example, the marker label data of the symbol item 331 could be edited via the editing module 35 by selecting one or more of the marker labels t on the shoe upper of the 3D image data P through the editing module 35, wherein the processing parameters corresponding to one of the marker label data could be edited through the editing module 35. Additionally, the marker label t on surfaces of the 3D image data P, which corresponds to different processing surfaces 2 of the object 1, could be selected via the editing module 35 for presetting processing parameter of corresponding processing item 332, as shown in FIG. 4, FIG. 9, and FIG. 13. The processing pattern of the marker label t on the surface of the 3D image data P corresponding to the shoe upper of the object 1 could be set as a rectangular hole; the processing pattern of the marker label t on the surface of the 3D image data P corresponding to the shoe side of the object 1 could be set as a star-shaped hole; and, the processing pattern of the marker label t on the surface of the 3D image data P corresponding to the circumference of shoe sole of the object 1 could be set as an alphabet pattern. Thus, the processing parameter corresponding to the shoe upper and the shoe side of the object 1 could be different, thereby providing customized surface processing.

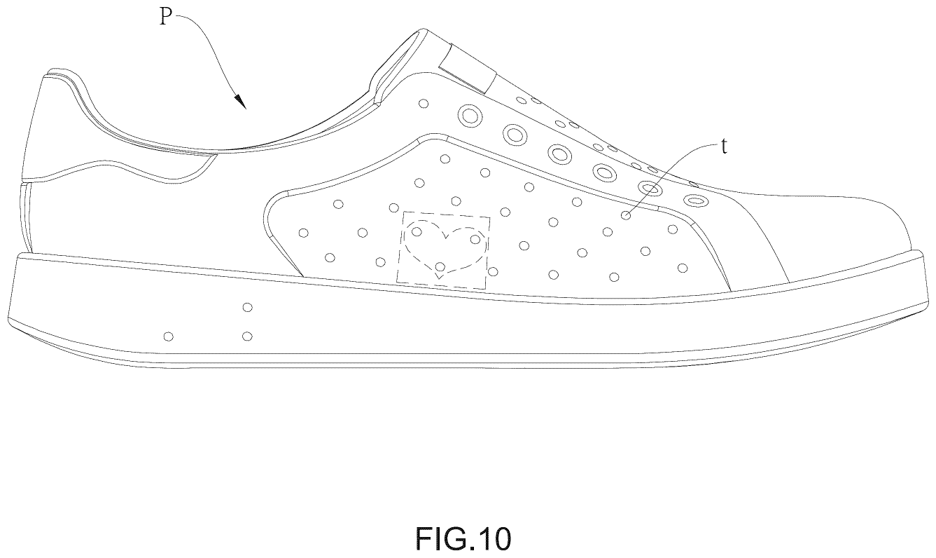

Additionally, the editing module 35 be used to set an editing area, as an area encircled by broken lines shown in FIG. 10, wherein the editing area has a plurality of marker labels t. The editing module 35 accesses at least one processing parameter in the processing database 33 and set the processing pattern of the processing parameter in the editing area. As illustrated in FIG. 10, the processing pattern is heart-shaped. The editing module 35 could automatically set the heart-shaped pattern in the editing area according to the distribution of the marker labels t in the editing area. The path calculation module 34 calculates a processing path for the editing area, and the coordinate of 3D processing of the marker label t are located on the processing path, wherein the path calculation module 34 could set the sequence of the processing path based on the location of the marker labels t in the editing area.

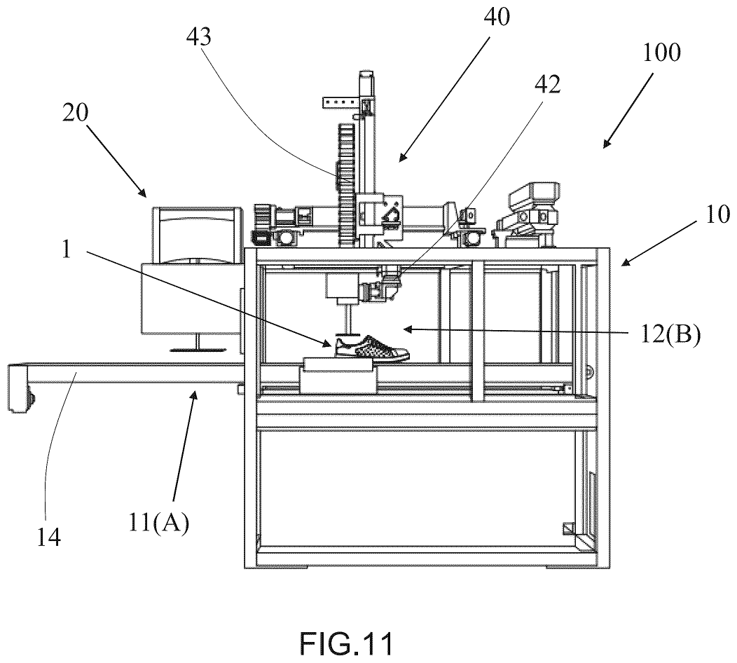

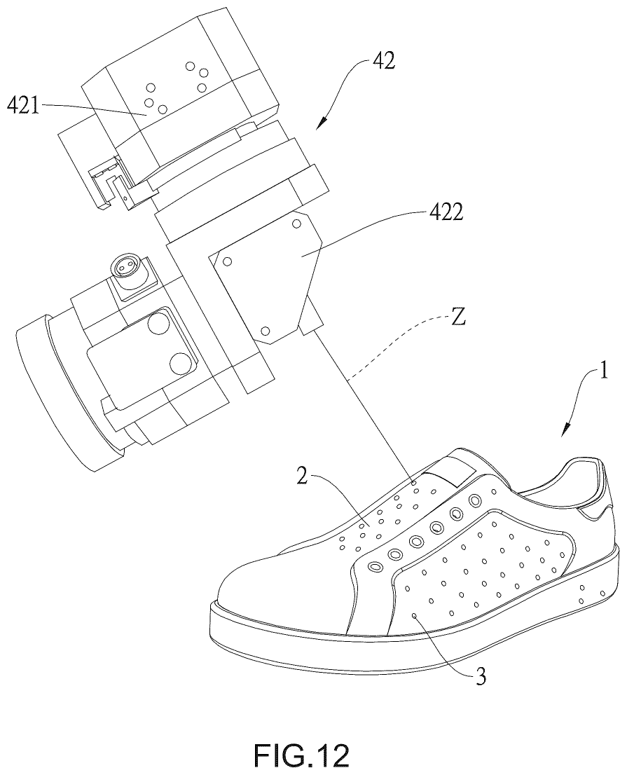

The surface processing apparatus 40 is connected to the computing device 30 and receives the 3D image data P from the computing device 30, so that the surface processing apparatus 40 performs surface processing to the 3D feature markers 3 on the processing surface 2 of the object 1 according to the coordinate of 3D processing and the processing path recorded by the computing device 30. As illustrated in FIG. 8, FIG. 11, and FIG. 12, the surface processing apparatus 40 includes a control module 41 and a surface processing module 42, wherein the control module 41 receives the 3D image data P and accesses the coordinate of 3D processing, the processing path, and other information recorded in the 3D image data P. The control module 41 controls the surface processing module 42 to move to a position where the surface processing module 42 could correspond to the processing surface 2 of the object 1 to perform surface processing to the 3D feature markers 3 on the processing surface 2.

In the embodiment, the surface processing module 42 includes a multi-axis robotic arm 421 and a laser cutting head 422. The multi-axis robotic arm 421 could rotate about multiple axes to drive the laser cutting head 422 to universally rotate according to a command of the control module 41. A processing axis Z of the laser cutting head 422 aims one of the 3D feature markers 3 on the object 1 and is perpendicular to a portion of the processing surface 2 of the object 1 that is processed, so that the laser cutting head 422 could process the processing surface 2 to form a straight hole on the processing surface 2, thereby promoting the yield rate of surface laser processing.

Additionally, the surface processing apparatus 40 includes a lifting seat 43, wherein the lifting seat 43 is connected to the multi-axis robotic arm 421 and could drive the multi-axis robotic arm 421 and the laser cutting head 422 to move up and down relative to the object 1 on the required demand to adjust the height of the multi-axis robotic arm 421. However, the structure of the surface processing module 42 is not limited to the abovementioned. In other embodiments, the surface processing module 42 could be replaced with any conventional surface processing component, such as a deburring machine, a glue applying machine, and other machines, on the required demand. In an embodiment, the lifting seat 43 could be omitted, as long as the surface processing module 42 could perform surface processing.

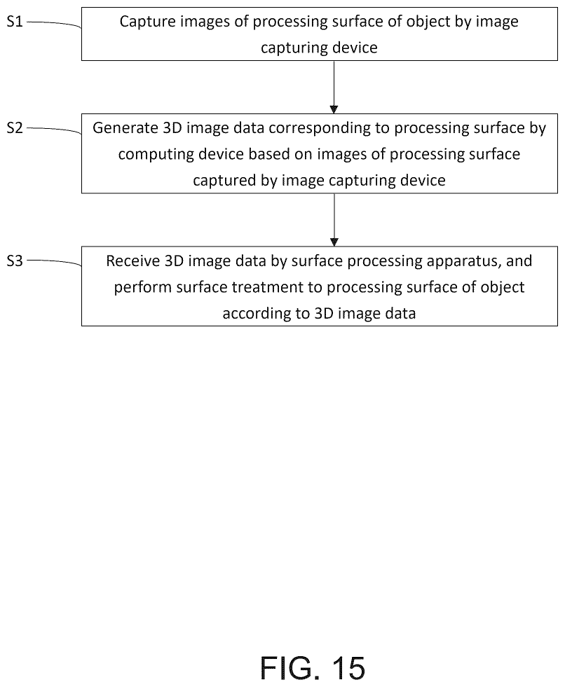

A processing method of an embodiment according to the present invention is performed by utilizing the processing system 100. The object 1 is the abovementioned shoe as an example. As illustrated in FIG. 6 to FIG. 15, the processing method includes the following steps:

Step S1: An image of the processing surface 2 of the object 1 is captured by the image capturing device 20. As illustrated in FIG. 6 and FIG. 7, when the object 1 is conveyed by the transmitting track 14 to enter into the first operating area A of the processing system 100, the object 1 stops right beneath the image capturing device 20 first. The drive module 22 of the image capturing device 20 drives the 3D camera module 21 to move along the arc slide track 221, so that the 3D camera module 21 could be manipulated by the drive module 22 to capture the processing surface 2 of the object 1 at various angles.

Step S2: The 3D image data P corresponding to the processing surface 2 is generated by the computing device 30 based on the images captured by the image capturing device 20. A method of image processing performed by the computing device 30 is described above. After the image processing module 31 of the computing device 30 receives the images captured by the image capturing device 20 to generate the 3D image data P corresponding to the processing surface 2, the marker labels t, which correspond to the 3D feature markers 3 of the object 1, are marked in the 3D image data P. Then, the mark identifying module 32 identifies each of the marker labels t in the 3D image data P and records the coordinate of 3D processing of each of the marker labels t.

The path calculation module 34 accesses the marker labels t in the 3D image data P and compares each of the marker labels t with the marker label data of the symbol item 331 in the processing database 33. When one or more of the marker labels t is consistent with any one of the marker label data of the symbol item 331, the path calculation module 34 accesses the processing parameter of the processing item 332, which corresponds to said marker label datum of the symbol item 331, from the processing database 33, and set the processing pattern of accessed processing parameter on the one or more of the marker labels t in the 3D image data. The path calculation module 34 generates the processing initial coordinate on the marker label t corresponding to the processing initial point of the processing pattern and calculates the processing path starting from the processing initial coordinate, the coordinate of 3D processing the one or more of the marker labels t is located on the processing path.

Additionally, the editing module 35 of the computing device 30 could set the editing area (namely, the area encircled by the broken line in FIG. 10) on the 3D image data P. The editing module 35 accesses a processing parameter from the processing database 33 and set the processing pattern of the processing parameter on the marker labels t in the editing area. The path calculation module 34 calculates the processing path in the editing area, the coordinate of 3D processing of the one or more of the marker labels t is located on the processing path.

Step S3: The surface processing apparatus 40 receives the 3D image data P from the computing device 30 and perform the surface processing to the processing surface 2 of the object 1 according to the 3D image data P. As illustrated in FIG. 10 and FIG. 11, when the object 1 passes through the entrance 13 and enters the second operating area B from the first operating area A, the object 1 stops right beneath the surface processing apparatus 40. After the control module 41 of the surface processing apparatus 40 receives the 3D image data P from the computing device 30, the control module 41 could read the processing path in the 3D image data P. The surface processing module 42 could be moved by the control module 41 to a position where the surface processing module 42 corresponds to each of the 3D feature markers 3 on the processing surface 2 to perform surface laser processing on the processing surface 2 of the object 1, thereby processing the object 1 to form a finished product 1′. Finally, the transmitting track 14 disposed on the shell 10 could convey the finished product 1′ out from the second operating area B.

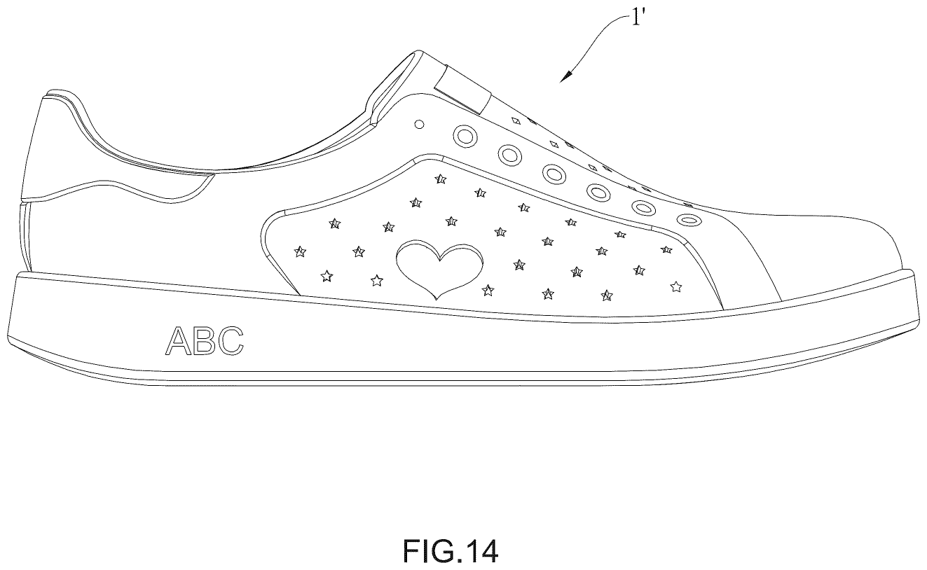

As illustrated in FIG. 4 and FIG. 5, FIG. 13, and FIG. 14, when the object 1 is compared with the finished product 1′, the finished product 1′ has a plurality of rectangular holes on the shoe upper, a plurality of star-shaped holes on the shoe side, and alphabet-shaped patterns on the circumference of shoe sole after the 3D feature markers 3 of the object 1 are processed by laser. Besides, the editing module 35 of the computing device 30 could set the editing area and a plurality of processing parameters in the 3D image data P, so that a portion of the shoe side of the finished product 1′ could have a heart-shaped hole to allow an appearance of the finished product 1′ to be varied, thereby increasing the viability of the surface processing.

The processing system 100 and the processing method thereof provided by the present invention could capture the images of the processing surface 2 of the object 1 via the image capturing device 20 when the object 1 is on the production line, wherein the image capturing device 20 could capture images of processing surfaces of each of various kinds of the objects. After that, the computing device 30 immediately generates the 3D image data P that corresponds to the processing surface 2 based on the images captured by the image capturing device 20 and identifies the location of the marker labels t and the processing parameter in the 3D image data P. Then, the surface processing apparatus 40 performs surface processing to the processing surface 2 of the object 1. With the processing method capable of automatically carrying out the surface processing, the cost of preparing the drawing of the object 1 could be saved. Additionally, the processing surfaces of various kinds of objects could be read by the computing device 30 and be processed to add different patterns and shapes in different sizes at the 3D feature markers of various kinds of the objects, thereby increasing the efficiency of the surface processing.

Furthermore, the multi-axis robotic arm 421 of the surface processing apparatus 40 could drive the laser cutting head 422 to rotate universally to allow the processing axis Z of the laser cutting head 422 could be perpendicular to a portion of the processing surface 2 of the object 1, so that the laser cutting head 422 could add straight holes on the processing surface 2, thereby solving the problem of flash or burr and improving the yield rate.

Moreover, the processing system 100 could be trained with the 3D feature markers 3 on the object 1. For example, the computing device 30 could learn to determine the various kinds of shapes of flash or burr and establish the symbol item 331 of the shape of flash or burr in the processing database 33. Thus, the processing system 100 could monitor and identify the flash or burr on the object 1, and then automatically cut or trim the flash or burr.

It must be pointed out that the embodiment described above is only a preferred embodiment of the present invention. All equivalent structures which employ the concepts disclosed in this specification and the appended claims should fall within the scope of the present invention.

What is claimed is:

1. A processing system capable of automatically monitoring surface features on an object, which is adapted to process a processing surface of the object, and the processing surface has at least one 3D feature marker; wherein the processing system comprises:
an image capturing device, adapted to capture images of the processing surface of the object;
a computing device connected to the image capturing device, wherein the computing device generates a 3D image data corresponding to the processing surface based on the images captured by the image capturing device, and the 3D image data comprises at least one marker label corresponding to the at least one 3D feature marker; the computing device records a coordinate of 3D processing corresponding to a location of the at least one marker label and calculates a processing path; and
a surface processing apparatus connected to the computing device and adapted to receive the 3D image data from the computing device, wherein the surface processing apparatus performs surface processing to the processing surface of the object according to the coordinate of 3D processing and the processing path in the 3D image data.

2. The processing system as claimed in claim 1, wherein the computing device comprises an image processing module; the image processing module receives the images captured by the image capturing device and performs an image processing to obtain the 3D image data corresponding to a profile of the processing surface of the object; the 3D image data has the at least one marker label.

3. The processing system as claimed in claim 1, wherein the computing device comprises a mark identifying module; the mark identifying module obtains the 3D image data to identify the at least one marker label in the 3D image data and records the coordinate of 3D processing corresponding to the location of the at least one marker label in the 3D image data.

4. The processing system as claimed in claim 1, wherein the computing device comprises a processing database; the processing database comprises a symbol item and a processing item; the symbol item prestores a plurality of marker label data, and the processing item presets a plurality of processing parameters corresponding to each of the plurality of marker label data.

5. The processing system as claimed in claim 4, wherein the computing device comprises a path calculation module; the path calculation module identifies the at least one marker label in the 3D image data and compares the at least one marker label with the symbol item in the processing database; when the at least one marker label is identical to one of the marker label data of the symbol item, the path calculation module obtains the processing parameters corresponding to the one of the marker label data of the symbol item from the processing item of the processing database and sets a processing pattern of the processing parameters on the at least one marker label in the 3D image data; the path calculation module generates a processing initial coordinate corresponding to a processing initial point of the processing pattern on the at least one marker label; the path calculation module calculate the processing path started from the processing initial coordinate, wherein the coordinate of 3D processing of the at least one marker label is located on the processing path.

6. The processing system as claimed in claim 5, wherein the at least one 3D feature marker on the processing surface comprises a plurality of 3D feature markers, and consequently the at least one marker label comprises a plurality of marker labels in the 3D image data; the computing device comprises an editing module; the editing module is adapted to set an editing area in the 3D image data, and the editing area comprises a portion of the plurality of marker labels; the editing module accesses at least one processing patterns from the processing database and sets the processing pattern on the portion of the plurality of marker labels in the editing area; the path calculation module calculates the processing path for the editing area, and the coordinates of 3D processing of the marker labels in the editing area are located on the processing path.

7. The processing system as claimed in claim 5, wherein the surface processing apparatus comprises a control module and a surface processing module; the control module receives the 3D image data and accesses the processing path recorded in the 3D image data to control the surface processing module to perform surface processing to the processing surface of the object.

8. The processing system as claimed in claim 7, wherein the surface processing module comprises a multi-axis robotic arm and a laser cutting head; the multi-axis robotic arm is moved according to a command from the control module to allow a processing axis of the laser cutting head to be aligned with the at least one 3D feature marker, wherein the processing axis is perpendicular to a portion of the processing surface of the object that is processed.

9. The processing system as claimed in claim 8, wherein the surface processing apparatus comprises a lifting seat; the lifting seat is connected to the multi-axis robotic arm to drive the multi-axis robotic arm and the laser cutting head to move up and down relative to the object.

10. The processing system as claimed in claim 1, further comprising a shell for being mounted with the image capturing device and the surface processing apparatus, wherein the processing system is defined to have a first operating area that is located at an outer space of the shell and a second operating area that is located at an inner space of the shell; the image capturing device is disposed in the first operating area, and the surface processing apparatus is disposed in the second operating area.

11. The processing system as claimed in claim 10, wherein the shell is disposed with a transmitting track providing for the object to put, and the transmitting track conveys the object to move through the first operating area and the second operating area.

12. The processing system as claimed in claim 10, wherein the image capturing device comprises a 3D camera module and a drive module; the 3D camera module is suspended in the first operating area, and the drive module drives the 3D camera module 21 to move within the first operating area; when the object enters into the first operating area, the 3D camera modules is controlled by the drive module to capture images of the processing surface of the object at various angles.

13. The processing system as claimed in claim 12, wherein the drive module comprises an arc slide track and a driver; the arc slide track is defined to have a center line that passes through a placement surface of the transmitting track; two ends of the arc slide track bend to the transmitting track; the driver disposed on the arc slide track to control the 3D camera module to move along the arc slide track.

14. The processing system as claimed in claim 11, wherein the image capturing device comprises a plurality of 3D camera modules; the plurality of 3D camera modules is fixed in the first operating area and faces the transmitting track; when the object enters into the first operating area, the 3D camera modules capture images of the processing surface of the object at various angles.

15. A processing method capable of automatically monitoring surface features on an object, which is adapted to process a processing surface of an object, and the processing surface has at least one 3D feature marker; wherein the processing method comprises:
step S1: capturing images of the processing surface of the object via an image capturing device;
step S2: generating a 3D image data corresponding to the processing surface by the computing device based on the images captured via the image capturing device; and
step S3: receiving the 3D image data by the surface processing apparatus and processing the processing surface of the object according to the 3D image data.

16. The method as claimed in claim 15, wherein in the step S1, the image capturing device utilizes a 3D camera module to capture images of the processing surface of the object, a drive module of the image capturing device drives the 3D camera module to move, so that the 3D camera module driven by the drive module is able to capture the processing surface of the object at various angles.

17. The method as claimed in claim 15, wherein in the step S2, after an image processing module of the computing device receives the images captured by the images capturing device, the image processing module performs an image processing to obtain the 3D image data corresponding to the processing surface; the 3D image data comprises at least one marker label corresponding to the at least one 3D feature markers.

18. The method as claimed in claim 17, wherein in the step S2, the computing device utilizes a mark identifying module to identify the at least one marker label in the 3D image data, and the mark identifying module records a coordinate of 3D processing corresponding to a location of the marker label.

19. The method as claimed in claim 18, wherein in the step S2, a path calculation module of the computing device identifies the at least one marker label in the 3D image data and compares the at least one marker label with a plurality of marker label data of the symbol item in the processing database; when the at least one marker label is identical to one of the plurality of marker label data of the symbol item, the path calculation module obtains the processing parameters corresponding to the one of the marker label data of the symbol item from the processing item of the processing database; a processing pattern of the processing parameters that corresponding to the one of the marker label data is set on the at least one marker label in the 3D image data; the path calculation module generates a processing initial coordinate corresponding to a processing initial point of the processing pattern on the at least one marker label; the path calculation module calculate a processing path started from the processing initial coordinate, wherein the coordinate of 3D processing of the at least one marker label is located on the processing path.

20. The method as claimed in claim 19, wherein in the step S2, an editing module of the computing device is adapted to set an editing area on the 3D image data, the editing module accesses at least one processing pattern from the processing parameters in the processing database to set on the at least one marker label in the editing area; the path calculation module calculates the processing path in the editing area, wherein the coordinate of 3D processing of the at least one marker label is located on the processing path.

21. The method as claimed in claim 19, wherein in the step S3, the surface processing apparatus utilizes a control module to receive the 3D image data and to access the processing path recorded in the 3D image data, thereby controlling a surface processing module of the surface processing module to perform surface processing to the processing surface of the object.
